(19) United States
(12) Patent Application Publication
(10) Pub. No.: US 2026/0213066 A1
(43) Pub. Date: Jul. 23, 2026

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masaya MURASHITA, Mie (JP); Kohei YOSHIKAWA, Mie (JP)

(21) Appl. No.: 19/142,962

(22) PCT Filed: Dec. 8, 2023
(86) PCT No.: PCT/JP2023/044032

§ 371 Date: Jun. 25, 2025

(30) Foreign Application Priority Data
Dec. 26, 2022 (JP) 2022-208308

(51) Int. Cl. H01F 37/00; H01F 3/08; H01F 3/14; H01F 27/26; H01F 27/34; H01F 27/38; H01F 41/02

(52) U.S. Cl. CPC H01F 37/00; H01F 3/08; H01F 3/14; H01F 27/263; H01F 27/346; H01F 27/38; H01F 41/0246

(57) ABSTRACT

This reactor comprises a coil and a magnetic core. The magnetic core comprises a first core and a second core. The first core includes a first end-core portion and at least a part of a side-core portion. The second core includes a second end-core portion and a remaining part of the side-core portion. At least one of the first core and the second core includes at least a part of a middle core portion. The side-core portion is disposed in parallel to the middle core portion with the coil therebetween. The first core is composed of a molding of a composite material in which a soft magnetic powder is dispersed in a resin. The first end-core portion has an inner surface, an outer surface, and a protruding portion provided on the outer surface. The protruding portion includes a first protruding portion and a second protruding portion. The first protruding portion is provided in a location corresponding to an interspace between the middle core portion and the first side-core portion. The second protruding portion is provided in a location corresponding to an interspace between the middle core portion and the second side-core portion.

### TECHNICAL FIELD

The present disclosure relates to a reactor, a converter, and a power conversion device.

The present application claims the benefit of priority based on Japanese Patent Application No. 2022-208308 filed on Dec. 26, 2022, which is incorporated herein by reference in its entirety.

### BACKGROUND

Components of a converter installed in a vehicle such as a hybrid vehicle include a reactor. A reactor includes a coil and a magnetic core. A reactor shown in FIGS. 5 to 8 of Patent Document 1 includes a coil and a magnetic core formed by combining two core pieces. The magnetic core is a so-called E-E type core composed of two E-shaped core pieces. The magnetic core has a θ shape formed by the two core pieces combined such that respective end surfaces of the core pieces face each other. The magnetic core includes end core portions, a middle core portion, and side core portions. The end core portions are disposed in such a manner as to face end surfaces of the coil. The middle core portion is disposed inside the coil. The side core portions are disposed in parallel with the middle core portion in such a manner as to sandwich the coil.

### PRIOR ART DOCUMENT

### Patent Document

Patent Document 1: JP 2016-201509 A

### SUMMARY OF THE INVENTION

A reactor according to the present disclosure includes a coil having a tubular shape; and a magnetic core having a θ shape, wherein the coil has a first end surface and a second end surface, the magnetic core includes a first core and a second core, the first core includes a first end core portion and at least a portion of side core portions, the second core includes a second end core portion and the remaining portion of the side core portions, at least one of the first core and the second core includes at least a portion of a middle core portion, the first end core portion is disposed in such a manner as to face the first end surface of the coil, the second end core portion is disposed in such a manner as to face the second end surface of the coil, the middle core portion is disposed inside the coil, the side core portions include a first side core portion and a second side core portion disposed in parallel with the middle core portion in such a manner as to sandwich the coil, the first core is constituted by a molded body of a composite material in which soft magnetic powder is dispersed in resin, the first end core portion has an inner surface to which a first end of the middle core portion, a first end of the first side core portion, and a first end of the second side core portion are joined an outer surface facing a side opposite to the inner surface and protrusions provided on the outer surface, the protrusions include a first protrusion and a second protrusion, the first protrusion is provided in a region of the outer surface between the middle core portion and the first side core portion, and the second protrusion is provided in a region of the outer surface between the middle core portion and the second side core portion.

### BRIEF DESCRIPTION OF THE DRAWINGS

FIG. 1 is a schematic perspective view showing a reactor according to Embodiment 1.

FIG. 2 is a schematic plan view showing the reactor according to Embodiment 1.

FIG. 3 is a schematic enlarged plan view showing a main part of the reactor shown in FIG. 2.

FIG. 4 is a schematic perspective view showing variation 1 of the reactor according to Embodiment 1.

FIG. 5 is a schematic perspective view showing variation 2 of the reactor according to Embodiment 1.

FIG. 6 is a schematic plan view showing a reactor according to Embodiment 2.

FIG. 7 is a schematic plan view showing a half of the reactor shown in FIG. 6.

FIG. 8 is a schematic plan view showing a variation of the reactor according to Embodiment 2.

FIG. 9 is a schematic plan view showing a half of the reactor shown in FIG. 8.

FIG. 10 is a configuration diagram schematically showing a power supply system of a hybrid vehicle.

FIG. 11 is a circuit diagram schematically showing a power conversion device including a converter.

### DETAILED DESCRIPTION TO EXECUTE THE INVENTION

### Technical Problem

It is desired to reduce loss of a coil due to magnetic flux leakage from a magnetic core.

An object of the present disclosure is to provide a reactor that can reduce the loss of a coil.

### Advantageous Effects of Invention

A reactor according to the present disclosure can reduce the loss of a coil.

### Description of Embodiments of the Present Disclosure

First, embodiments of the present disclosure will be listed and described.

(1) A reactor according to the present disclosure includes a coil having a tubular shape and a magnetic core having a θ shape, wherein the coil has a first end surface and a second end surface, the magnetic core includes a first core and a second core, the first core includes a first end core portion and at least a portion of side core portions, the second core includes a second end core portion and the remaining portion of the side core portions, at least one of the first core and the second core includes at least a portion of a middle core portion, the first end core portion is disposed in such a manner as to face the first end surface of the coil, the second end core portion is disposed in such a manner as to face the second end surface of the coil, the middle core portion is disposed inside the coil, the side core portions include a first side core portion and a second side core portion disposed in parallel with the middle core portion in such a manner as to sandwich the coil, the first core is constituted by a molded body of a composite material in which soft magnetic powder is dispersed in resin, the first end core portion has an inner surface to which a first end of the middle core portion, a first end of the first side core portion, and a first end of the second side core portion are joined an outer surface facing a side opposite to the inner surface and protrusions provided on the outer surface, the protrusions include a first protrusion and a second protrusion, the first protrusion is provided in a region of the outer surface between the middle core portion and the first side core portion, and the second protrusion is provided in a region of the outer surface between the middle core portion and the second side core portion.

The reactor according to the present disclosure can reduce the loss of the coil. In general, a molded body of a composite material has a low relative permeability. Accordingly, if the first core is constituted by a molded body of a composite material, magnetic flux leakage from the first end core portion is likely to occur. A loss occurs at the coil due to linkage between the leaking magnetic flux and the coil. The reactor according to the present disclosure includes the protrusions on the outer surface of the first end core portion, and therefore, the first end core portion has a large magnetic path area. Magnetic flux leakage from the first end core portion is unlikely to occur, and therefore, it is possible to suppress magnetic flux leakage resulting in the linkage with the coil. As a result of the reduction of the magnetic flux leakage to the coil, the loss of the coil can be reduced. In particular, the first protrusion and the second protrusion are provided in the specific regions of the outer surface of the first end core portion, and accordingly, the magnetic flux leakage from the first end core portion to the coil can be effectively suppressed, and the loss of the coil can be effectively reduced.

(2) In the reactor according to (1) described above, the first protrusion and the second protrusion may each have a length that is at least 0.05 times a length of the first end core portion and no greater than 0.5 times the length of the first end core portion.

This configuration (2) makes it possible to effectively reduce the loss of the coil while suppressing an increase in the volume of the first core. If the length of each protrusion is at least 0.05 times the length of the first end core portion, magnetic flux leakage from the first end core portion to the coil can be effectively suppressed. If the length of each protrusion is no greater than 0.5 times the length of the first end core portion, an increase in the volume of the first end core portion can be suppressed.

(3) In the reactor according to (1) or (2) described above, the first protrusion may have a width that is at least 0.2 times a distance between the middle core portion and the first side core portion and no greater than 1.0 times the distance between the middle core portion and the first side core portion, and the second protrusion may have a width that is at least 0.2 times a distance between the middle core portion and the second side core portion and no greater than 1.0 times the distance between the middle core portion and the second side core portion.

This configuration (3) makes it possible to effectively reduce the loss of the coil while suppressing an increase in the volume of the first core. If the width of each protrusion is at least 0.2 times the distance between the middle core portion and each side core portion, magnetic flux leakage from the first end core portion to the coil can be effectively suppressed. If the width of each protrusion is no greater than 1.0 times the distance between the middle core portion and each side core portion, an increase in the volume of the first end core portion can be suppressed.

(4) In the reactor according to any one of (1) to (3) described above, the first core may have a relative permeability of 5 or more and 50 or less.

A predetermined inductance can be easily obtained with this configuration (4).

(5) In the reactor according to any one of (1) to (4) described above, the middle core portion may include a first middle core portion and a second middle core portion, the first middle core portion may be joined to the first end core portion, and the second middle core portion may be joined to the second end core portion.

This configuration (5) makes it possible to make the first middle core portion and the second middle core portion have different magnetic properties. This configuration enables adjustment of magnetic properties of the magnetic core as a whole.

(6) In the reactor according to (5) described above, the middle core portion may include a gap portion between the first middle core portion and the second middle core portion.

This configuration (6) enables adjustment of the magnetic properties of the magnetic core as a whole due to the gap portion.

(7) In the reactor according to any one of (1) to (6) described above, the first core may include the entire side core portions, the first core may have a relative permeability that is lower than a relative permeability of the second core, the first side core portion and the second side core portion may each have the first end that is joined to the first end core portion and a second end that is joined to the second end core portion, a second distance between the coil and each of the first side core portion and the second side core portion at the second end may be larger than a first distance between the coil and each of the first side core portion and the second side core portion at the first end, and a ratio between the first distance and the second distance may be 0.32 or more and 0.70 or less.

This configuration (7) makes it possible to further reduce the loss of the coil. If the side core portions have a low relative permeability and the second end core portion has a high relative permeability, there is a risk that a magnetic flux may leak making a shortcut from the side core portions to the second end core portion in the vicinity of the second end. A loss occurs at the coil due to linkage between the leaking magnetic flux and the coil. According to the configuration (7) described above, the second distance at the second end is larger than the first distance at the first end, and therefore, it is possible to suppress magnetic flux leakage resulting in the linkage with the coil. As a result of the reduction of the magnetic flux leakage to the coil, the loss of the coil can be reduced. If the ratio between the first distance and the second distance is 0.70 or less, the magnetic flux leakage to the coil is sufficiently suppressed, and accordingly, the loss of the coil can be effectively reduced. In particular, if the ratio between the first distance and the second distance is 0.32 or more and 0.70 or less, it is possible to effectively reduce the loss of the coil while suppressing a reduction in the inductance.

If the first core and the second core have different magnetic properties, it is possible to adjust the magnetic properties of the magnetic core as a whole. If the relative permeability of the first core is lower than the relative permeability of the second core, the predetermined inductance can be easily obtained.

(8) In the reactor according to (7) described above, the first side core portion and the second side core portion may each have a tapered shape whose width decreases in a direction from the first end toward the second end.

The loss of the coil can be easily reduced with this configuration (8).

(9) In the reactor according to (7) described above, the first side core portion and the second side core portion may each have a stepped shape whose width decreases in a direction from the first end toward the second end.

The loss of the coil can be easily reduced with this configuration (9).

(10) In the reactor according to any one of (1) to (9) described above, the second core may have a relative permeability of 100 or more and 500 or less.

The predetermined inductance can be easily obtained with this configuration (10).

(11) In the reactor according to any one of (1) to (10) described above, the second core may be constituted by a powder compact.

In general, a powder compact has a high relative permeability. The configuration (11) makes it easier to obtain a magnetic core in which the relative permeability of the first core is lower than the relative permeability of the second core. If the second core is constituted by a powder compact, it is easy to adjust the relative permeability of the second core so as to fall within the range of 100 or more and 500 or less, for example.

(12) A converter according to the present disclosure includes the reactor according to any one of (1) to (11) described above.

The converter according to the present disclosure includes the reactor according to the present disclosure, and therefore, the loss is small.

(13) A power conversion device according to the present disclosure includes the converter according to (12) described above.

The power conversion device according to the present disclosure includes the converter according to the present disclosure, and therefore, the loss is small.

### Details of Embodiments of the Present Disclosure

The following describes specific embodiments of the present disclosure with reference to the drawings. The same reference numerals shown in the drawings denote components having the same name. Note that the present invention is not limited to these examples, but is defined by the claims, and is intended to encompass all alterations within the meanings and scope that are equivalent to the claims.

### Embodiment 1

### [Reactor]

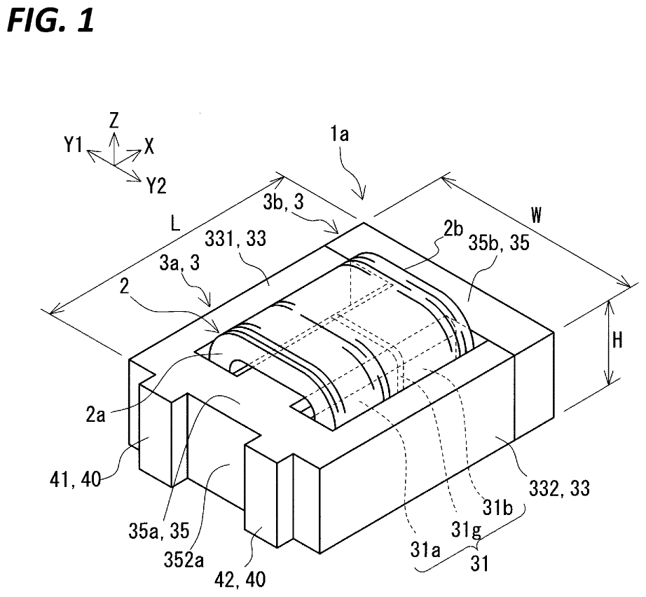

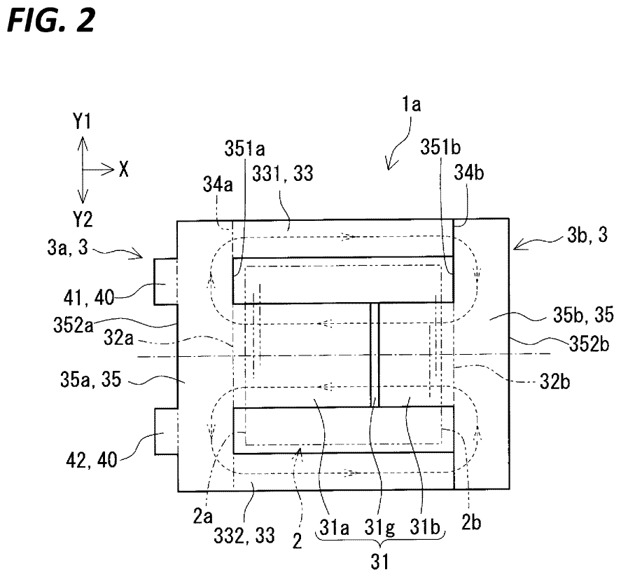

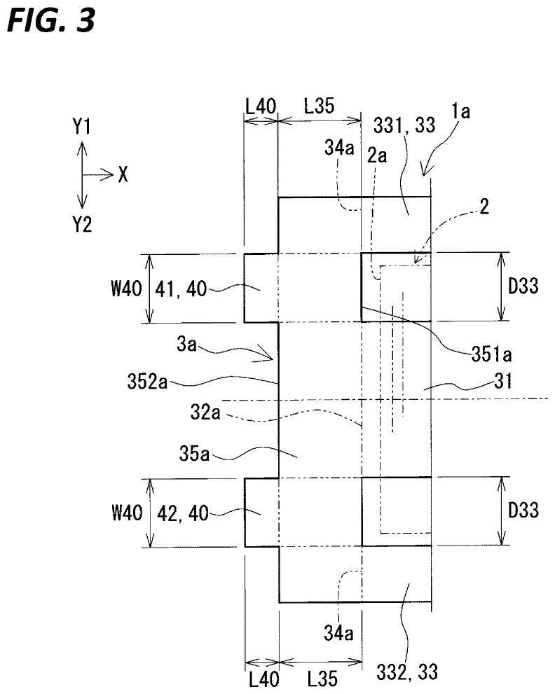

The following describes a reactor 1a according to Embodiment 1 with reference to FIGS. 1 to 3. The reactor 1a includes a coil 2 and a magnetic core 3. The magnetic core 3 includes a first core 3a and a second core 3b. As shown in FIG. 2, the magnetic core 3 is formed by combining the first core 3a and the second core 3b. The magnetic core 3 has a θ shape formed by a middle core portion 31, side core portions 33, and end core portions 35. FIG. 1 is a perspective view showing the reactor 1a as viewed from above. FIG. 2 is a plan view showing the reactor 1a as viewed from above. FIG. 3 is an enlarged plan view showing a part of the reactor 1a near a first end core portion 35a shown in FIG. 2.

The reactor 1a according to Embodiment 1 is characterized in satisfying the following requirements (a) and (b).

(a) The first core 3a is constituted by a molded body of a composite material.

(b) Protrusions 40 are provided on an outer surface 352a of the first end core portion 35a included in the first core 3a.

The reactor 1a includes the protrusions 40 on the outer surface 352a of the first end core portion 35a, and therefore, the loss of the coil 2 can be reduced. In particular, the protrusions 40 are provided in specific regions of the outer surface 352a of the first end core portion 35a, and therefore, the loss of the coil 2 can be effectively reduced. The following describes the configuration of the reactor 1a in detail.

### <Coil>

As shown in FIGS. 1 and 2, the coil 2 is disposed around the middle core portion 31 of the magnetic core 3. The coil 2 has a tubular shape. The coil 2 has a first end surface 2a and a second end surface 2b. In the present embodiment, the coil 2 is an edgewise coil formed by winding a rectangular wire edgewise.

The coil 2 may have a polygonal tube shape or a cylindrical tube shape. The polygonal tube shape means that the outline of each end surface of the coil 2 forms a polygonal shape. Examples of the polygonal shape include quadrilateral shapes, hexagonal shapes, and octagonal shapes. The quadrilateral shapes include rectangular shapes. The rectangular shapes include a square shape. The quadrilateral shapes include not only geometrical quadrilateral shapes but also shapes formed by connecting four corner portions. That is to say, the quadrilateral shapes include quadrilateral shapes whose details are altered, such as a shape whose four corner portions are rounded by chamfering and a shape whose four corner portions are linearly chamfered. This also applies to the shapes of the protrusions 40, which will be described later. The cylindrical tube shape means that the outline of each end surface of the coil 2 forms a circular shape. Examples of the circular shape include not only a perfect circle shape but also elliptical shapes. In the present embodiment, the coil 2 has a rectangular tube shape.

### <Magnetic Core>

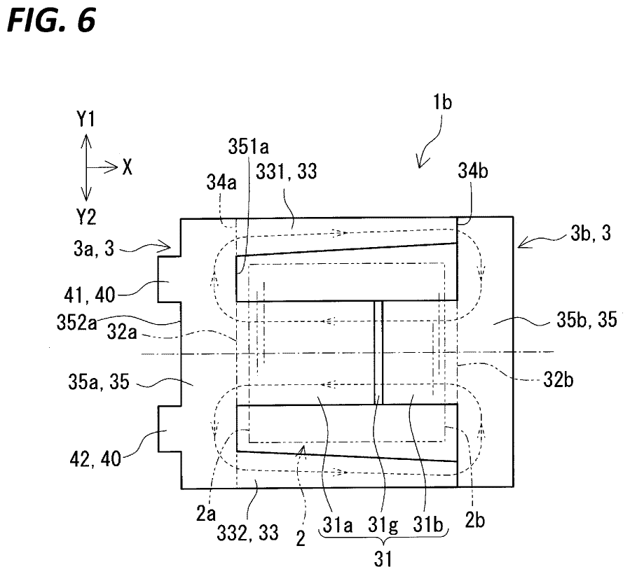

As shown in FIGS. 1 and 2, the magnetic core 3 includes the middle core portion 31, the side core portions 33, and the end core portions 35. In FIGS. 2 and 3, boundaries between the middle core portion 31 and the end core portions 35 and boundaries between the side core portions 33 and the end core portions 35 are shown with two-dot-dash lines. This also applies to FIGS. 6 to 9, which will be described later. As shown in FIG. 2, the magnetic core 3 has a θ shape in a plan view.

In the following description, an X-axis direction, Y-axis directions, and a Z-axis direction are defined as follows. The X-axis direction is a direction from the first end surface 2a toward the second end surface 2b along the axis of the coil 2. The Y-axis directions are directions from the middle core portion 31 toward the side core portions 33, and the middle core portion 31 and the side core portions 33 are disposed side by side in the Y-axis directions. The Y-axis directions are orthogonal to the X-axis direction. The direction from the middle core portion 31 toward a first side core portion 331 will be referred to as a “Y1 direction”. The direction from the middle core portion 31 toward a second side core portion 332 will be referred to as a “Y2 direction”. The Z-axis direction is orthogonal to both the X-axis direction and the Y-axis directions. The Z-axis direction is the upward direction when an XY plane including the X axis and the Y axis extends horizontally.

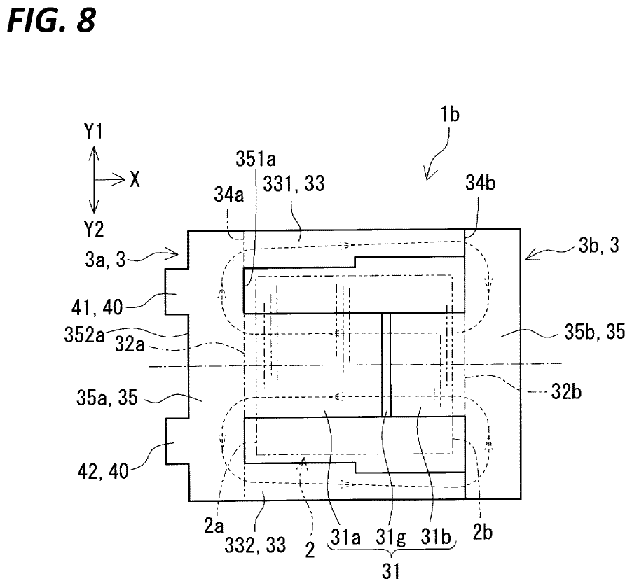

The magnetic core 3 forms a θ-shaped closed magnetic path. When electricity passes through the coil 2, magnetic flux flows through the magnetic core 3. The magnetic flux generated by the coil 2 flows from the middle core portion 31 via the end core portions 35 and the side core portions 33 and returns to the middle core portion 31. Broken line arrows in FIG. 2 show flows of the magnetic flux. This also applies to FIGS. 6 and 8, which will be described later.

### (Middle Core Portion)

The middle core portion 31 is disposed inside the coil 2 as shown in FIG. 2. The magnetic core includes one middle core portion 31. The middle core portion 31 extends in the X-axis direction. The longitudinal direction of the middle core portion 31 extends along the axis of the coil 2. The length of the middle core portion 31 is equal to or longer than the length of the coil 2. The length referred to here means a distance along the X-axis direction. Two end portions of the middle core portion 31 may protrude from the two end surfaces of the coil 2. The protruding portions are also included in the middle core portion 31. The middle core portion 31 has a shape corresponding to an inner shape of the coil 2. In the present embodiment, the middle core portion 31 has a substantially rectangular parallelepiped shape.

The middle core portion 31 is disposed between the first end core portion 35a and a second end core portion 35b. The first end core portion 35a and the second end core portion 35b will be described later. The middle core portion 31 has a first end 32a and a second end 32b. The first end 32a is joined to the first end core portion 35a. The second end 32b is joined to the second end core portion 35b.

In the present embodiment, the middle core portion 31 includes a first middle core portion 31a and a second middle core portion 31b. The first middle core portion 31a and the second middle core portion 31b are arranged in series along the X-axis direction. The boundary between the first middle core portion 31a and the second middle core portion 31b is located inside the coil 2. The first middle core portion 31a includes the first end 32a joined to the first end core portion 35a. The second middle core portion 31b includes the second end 32b joined to the second end core portion 35b. The wording “joined” means that the two portions are connected and not separable from each other. The first middle core portion 31a and the first end core portion 35a may be formed as a single piece. If the first middle core portion 31a and the first end core portion 35a are separate components independent of each other, the first end 32a may be bonded to the first end core portion 35a, or at least a portion of the first middle core portion 31a and at least a portion of the first end core portion 35a may be combined by being covered by a resin mold, for example. The second middle core portion 31b and the second end core portion 35b may be formed as a single piece. If the second middle core portion 31b and the second end core portion 35b are separate components independent of each other, the second end 32b may be bonded to the second end core portion 35b, or at least a portion of the second middle core portion 31b and at least a portion of the second end core portion 35b may be combined by being covered by a resin mold, for example. The resin molds are molded members formed so as to continuously cover at least a portion of the first core 3a and at least a portion of the second core 3b. In the present embodiment, the first middle core portion 31a and the first end core portion 35a are formed as a single piece. The second middle core portion 31b and the second end core portion 35b are formed as a single piece.

The lengths of the first middle core portion 31a and the second middle core portion 31b can be set as appropriate. In the present embodiment, the length of the first middle core portion 31a differs from the length of the second middle core portion 31b. The first middle core portion 31a is longer than the second middle core portion 31b. The first middle core portion 31a may be shorter than the second middle core portion 31b. The length of the first middle core portion 31a may be the same as the length of the second middle core portion 31b.

In the present embodiment, the middle core portion 31 includes a gap portion 31g. The gap portion 31g is provided between the first middle core portion 31a and the second middle core portion 31b. The inductance can be adjusted because the middle core portion 31 includes the gap portion 31g. The gap portion 31g is located inside the coil 2. If the gap portion 31g is located inside the coil 2, magnetic flux leakage from the gap portion 31g is smaller than that of a case where the gap portion 31g is exposed from the coil 2. Therefore, it is easy to suppress linkage between a magnetic flux leaking from the gap portion 31g and the coil 2. It is possible to reduce loss due to the magnetic flux leakage from the gap portion 31g. The length of the gap portion 31g is set as appropriate such that a predetermined inductance can be obtained. The length of the gap portion 31g is, for example, 0.1 mm or more and 3 mm or less, 0.3 mm or more and 2.5 mm or less, or 0.5 mm or more and 2 mm or less. The gap portion 31g may also be an air gap. The gap portion 31g may be constituted by a non-magnetic member formed of resin or ceramics, for example. When the middle core portion 31 includes the gap portion 31g, the length of the middle core portion 31 is the sum of the length of the first middle core portion 31a, the length of the second middle core portion 31b, and the length of the gap portion 31g. A configuration is also possible in which the middle core portion does not include the gap portion 31g. If the middle core portion does not include the gap portion 31g, the first middle core portion 31a and the second middle core portion 31b are in contact with each other and there is no substantial gap between the first middle core portion 31a and the second middle core portion 31b.

### (Side Core Portions)

The side core portions 33 are disposed outside the coil 2 as shown in FIG. 2. The side core portions 33 are disposed in parallel with the middle core portion 31 in such a manner as to sandwich the coil 2. Inner surfaces of the side core portions 33 face an outer circumferential surface of the coil 2. The magnetic core includes two side core portions 33. The side core portions 33 extend in the X-axis direction. The longitudinal direction of the side core portions 33 is parallel to the longitudinal direction of the middle core portion 31. The lengths of the side core portions 33 are equivalent to the length of the middle core portion 31.

The side core portions 33 include the first side core portion 331 and the second side core portion 332. The first side core portion 331 and the second side core portion 332 are spaced apart from each other in the Y-axis directions. The first side core portion 331 is spaced apart from the middle core portion 31 in the Y1 direction. The second side core portion 332 is spaced apart from the middle core portion 31 in the Y2 direction. In the present embodiment, the first side core portion 331 and the second side core portion 332 are disposed symmetrically with each other with respect to a center line of the middle core portion 31.

The first side core portion 331 and the second side core portion 332 are disposed between the first end core portion 35a and the second end core portion 35b. The first side core portion 331 and the second side core portion 332 each have a first end 34a and a second end 34b. The first end 34a is joined to the first end core portion 35a. The second end 34b is joined to the second end core portion 35b. It is sufficient that the first side core portion 331 and the second side core portion 332 each have a length sufficient to connect the first end core portion 35a and the second end core portion 35b. The first side core portion 331 and the second side core portion 332 may each have a suitable shape. In the present embodiment, the first side core portion 331 and the second side core portion 332 each have a substantially rectangular parallelepiped shape. The shape of the first side core portion 331 and the shape of the second side core portion 332 are symmetrical with each other with respect to the center line of the middle core portion 31.

In the present embodiment, the side core portions 33 and the first end core portion 35a are formed as a single piece. The side core portions 33 and the first end core portion 35a may be separate components independent of each other. In this case, the first ends 34a may be bonded to the first end core portion 35a, or at least a portion of the side core portions 33 and at least a portion of the first end core portion 35a may be combined by being covered by a resin mold, for example. In the present embodiment, the side core portions 33 and the second end core portion 35b are separate components independent of each other. The side core portions 33 and the second end core portion 35b are combined by being covered by a resin mold (not shown). The second ends 34b of the side core portions 33 may be bonded to the second end core portion 35b.

### (End Core Portions)

The end core portions 35 are disposed outside the coil 2 as shown in FIG. 2. The end core portions 35 are disposed in such a manner as to face the two end surfaces of the coil 2. The magnetic core includes two end core portions 35. The end core portions 35 include the first end core portion 35a and the second end core portion 35b. The first end core portion 35a faces the first end surface 2a of the coil 2. The second end core portion 35b faces the second end surface 2b of the coil 2. The first end core portion 35a and the second end core portion 35b are spaced apart from each other in the X-axis direction.

The first end core portion 35a has an inner surface 351a and the outer surface 352a. The second end core portion 35b has an inner surface 351b and an outer surface 352b. The inner surface 351a of the first end core portion 35a and the inner surface 351b of the second end core portion 35b face each other. The first end 32a of the middle core portion 31 and the first ends 34a of the first side core portion 331 and the second side core portion 332 are joined to the inner surface 351a of the first end core portion 35a. The outer surface 352a of the first end core portion 35a faces the side opposite to the inner surface 351a. That is to say, the outer surface 352a faces the direction away from the first end 32a and the first ends 34a. The second end 32b of the middle core portion 31 and the second ends 34b of the first side core portion 331 and the second side core portion 332 are joined to the inner surface 351b of the second end core portion 35b. The outer surface 352b of the second end core portion 35b faces the side opposite to the inner surface 351b. That is to say, the outer surface 352b faces the direction away from the second end 32b and the second ends 34b.

### <Protrusions>

In the present embodiment, the first end core portion 35a includes the protrusions 40. The protrusions 40 are provided on the outer surface 352a of the first end core portion 35a. The protrusions 40 protrude in the direction away from the inner surface 351a. As shown in FIG. 1, the protrusions 40 extend from an upper edge to a lower edge of the outer surface 352a in the Z-axis direction. That is to say, the protrusions 40 span the entire height of the first end core portion 35a.

In the present embodiment, the number of protrusions 40 is two as shown in FIG. 2. The protrusions 40 include a first protrusion 41 and a second protrusion 42. The first protrusion 41 is provided in a region of the outer surface 352a between the middle core portion 31 and the first side core portion 331. The region of the outer surface 352a between the middle core portion 31 and the first side core portion 331 is a region between a virtual line extending in the X-axis direction from an outer circumferential surface of the middle core portion 31 at the first end 32a and a virtual line extending in the X-axis direction from the inner surface of the first side core portion 331 at the first end 34a in a plan view. The first protrusion 41 is located in this region. Hereinafter, this region will be referred to as a “first outer region”. The second protrusion 42 is provided in a region of the outer surface 352a between the middle core portion 31 and the second side core portion 332. The region of the outer surface 352a between the middle core portion 31 and the second side core portion 332 is a region between a virtual line extending in the X-axis direction from an outer circumferential surface of the middle core portion 31 at the first end 32a and a virtual line extending in the X-axis direction from the inner surface of the second side core portion 332 at the first end 34a in a plan view. The second protrusion 42 is located in this region. Hereinafter, this region will be referred to as a “second outer region”. In the present embodiment, the first protrusion 41 and the second protrusion 42 are disposed symmetrically with each other with respect to the center line of the middle core portion 31.

Magnetic flux leakage from the first end core portion 35a to the coil 2 can be suppressed due to the first end core portion 35a including the protrusions 40. As a result of the reduction of the magnetic flux leakage from the first end core portion 35a to the coil 2, the loss of the coil 2 can be reduced. In particular, if the first protrusion 41 and the second protrusion 42 are provided in the specific regions of the outer surface 352a of the first end core portion 35a, the magnetic flux leakage from the first end core portion 35a to the coil 2 can be effectively suppressed, and accordingly, the loss of the coil 2 can be effectively reduced.

### <Material of Protrusions>

The protrusions 40 are formed of a soft magnetic material. The protrusions 40 and the first end core portion 35a may be formed as a single piece, or may be separate components independent of each other. If the protrusions 40 and the first end core portion 35a are formed as a single piece, the protrusions 40 and the first end core portion 35a are formed of the same material. If the protrusions 40 and the first end core portion 35a are separate components independent of each other, the protrusions 40 may be formed from a molded body of a composite material, a powder compact, or a plate of a soft magnetic metal, for example. The soft magnetic metal is, for example, iron. If the protrusions 40 and the first end core portion 35a are separate components independent of each other, the protrusions 40 may be bonded to the outer surface 352a of the first end core portion 35a, or the protrusions 40 and the first end core portion 35a may be combined by a resin mold. In the present embodiment, the protrusions 40 and the first end core portion 35a are formed as a single piece.

### <Shape of Protrusions>

The protrusions 40 may have a suitable shape. The shape of the protrusions 40 referred to here means a shape in a plan view. The shape of the protrusions 40 is, for example, a polygonal shape or an arcuate shape. Examples of the polygonal shape include triangular shapes, quadrilateral shapes, pentagonal shapes, and hexagonal shapes. Examples of the quadrilateral shapes include rectangular shapes and trapezoidal shapes. The rectangular shapes include a square shape. Corners of the protrusions 40 may be chamfered. An arcuate shape includes an arc. Examples of the arcuate shape include semicircular shapes and semi-elliptical shapes. The first protrusion 41 and the second protrusion 42 may have the same shape or different shapes. In the present embodiment, the first protrusion 41 and the second protrusion 42 each have a rectangular shape.

The following describes the length and the width of the protrusions 40 with reference to FIG. 3. FIG. 3 shows a part of the reactor 1a including the first end portion 35a of the first core 3a shown in FIG. 2.

### <Length of Protrusions

The first protrusion 41 and the second protrusion 42 each have a length that is at least 0.05 times the length of the first end core portion 35a and no greater than 0.5 times the length of the first end core portion 35a, for example. That is to say, a ratio between the length L40 of each protrusion 40 and the length L35 of the first end core portion 35a is 0.05 or more and 0.5 or less. The ratio between the length L40 and the length L35 is expressed as L40/L35. The length referred to here means a distance along the X-axis direction. The length L35 of the first end core portion 35a corresponds to a distance from the inner surface 351a to the outer surface 352a in a portion to which the first end 32a of the middle core portion 31 is joined. The length L40 of each protrusion 40 corresponds to a distance from a virtual plane extending in the Y-axis directions from the portion of the outer surface 352a to which the first end 32a of the middle core portion 31 is joined to a distal end of the protrusion 40. The length L40 is equal to a difference between a distance from the inner surface 351a to the distal end of the protrusion 40 and the length L35 of the first end core portion 35a.

If the length L40 is at least 0.05 times the length L35, i.e., if the ratio L40/L35 is 0.05 or more, magnetic flux leakage from the first end core portion 35a to the coil 2 can be effectively suppressed. From the viewpoint of suppressing the magnetic flux leakage, the ratio L40/L35 may be 0.1 or more, or 0.2 or more. If the length L40 is no greater than 0.5 times the length L35, i.e., if the ratio L40/L35 is 0.5 or less, an increase in the volume of the first end core portion 35a can be suppressed. The ratio L40/L35 may be 0.1 or more and 0.5 or less, or 0.2 or more and 0.5 or less, for example.

### <Width of Protrusions>

The width of the first protrusion 41 is, for example, at least 0.2 times a distance D33 between the middle core portion 31 and the first side core portion 331 and no greater than 1.0 times the distance D33. The width of the second protrusion 42 is, for example, at least 0.2 times a distance between the middle core portion 31 and the second side core portion 332 and no greater than 1.0 times the distance. That is to say, a ratio between the width W40 of each protrusion 40 and the distance D33 between the middle core portion 31 and each side core portion 33 is 0.2 or more and 1.0 or less. The ratio between the width W40 and the distance D33 is expressed as W40/D33. The distance D33 is a distance between the outer circumferential surface of the middle core portion 31 and the inner surface of the side core portion 33. The distance D33 is the distance at the first end 32a of the middle core portion 31 and the first end 34a of the side core portion 33. The distance D33 is equal to the width of the first outer region and the width of the second outer region in the outer surface 352a described above. The width referred to here means a distance along the Y-axis directions. The width W40 of each protrusion 40 is a distance along the Y-axis directions. The width W40 corresponds to the maximum distance between a side surface of the protrusion 40 facing the Y1 direction and a side surface of the protrusion 40 facing the Y2 direction. The width W40 is equal to a distance between two lines extending in parallel to the X-axis and sandwiching the protrusion 40.

If the width W40 is at least 0.2 times the distance D33, i.e., if the ratio W40/D33 is 0.2 or more, magnetic flux leakage from the first end core portion 35a to the coil 2 can be effectively suppressed. From the viewpoint of suppressing the magnetic flux leakage, the ratio W40/D33 may be 0.3 or more, or 0.4 or more. If the width W40 is no greater than 1.0 times the distance D33, i.e., if the ratio W40/D33 is 1.0 or less, an increase in the volume of the first end core portion 35a can be suppressed. The ratio W40/D33 may be 0.3 or more and 1.0 or less, or 0.4 or more and 1.0 or less, for example. An example of the ratio W40/D33 in FIG. 3 is 1.0.

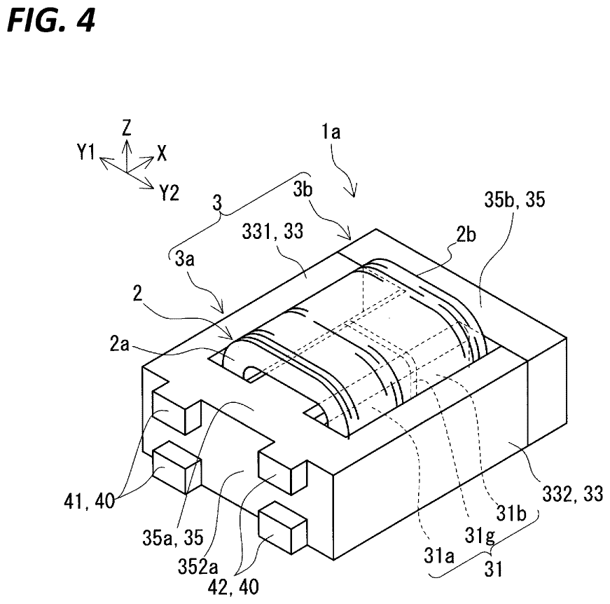

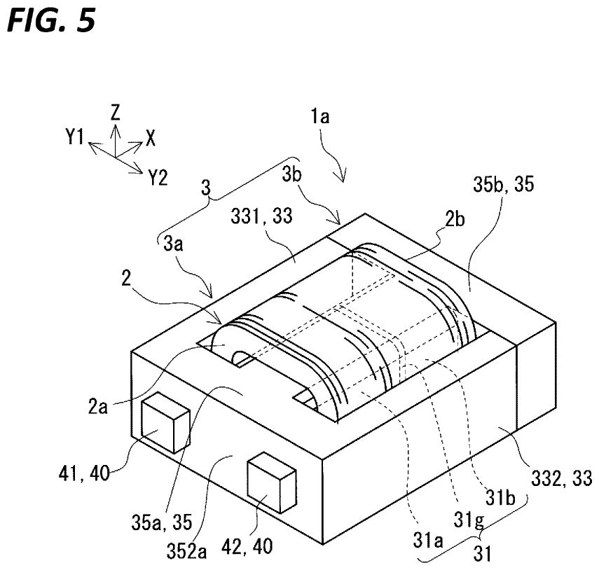

As shown in FIGS. 4 and 5, the protrusions 40 may also be provided in a part of the first end core portion 35a in the height direction. For example, the protrusions 40 may be divided into a plurality of portions separate from each other in the Z-axis direction as in variation 1 shown in FIG. 4. In the variation 1, the protrusions 40 are disposed in a part near the upper edge and a part near the lower edge of the outer surface 352a. For example, the protrusions 40 may also be disposed only in a center portion of the outer surface 352a as in variation 2 shown in FIG. 5. If the protrusions 40 are provided in a part of the first end core portion 35a in the height direction, the protrusions 40 are provided in a part that constitutes ½ or more of the height of the first end core portion 35a, for example. In the variation 1 shown in FIG. 4, the part near the upper edge of the outer surface 352a is a region that constitutes ¼ of the outer surface 352a from the upper edge when the outer surface is equally divided into four regions in the Z-axis direction. The part near the lower edge of the outer surface 352a is a region that constitutes ¼ of the outer surface 352a from the lower edge when the outer surface is equally divided into four regions in the Z-axis direction. In the variation 2 shown in FIG. 5, the center portion of the outer surface 352a is a center region that constitutes ½ of the outer surface 352a when the outer surface is equally divided into four regions in the Z-axis direction. The protrusions 40 in the variation 1 and the protrusions 40 in the variation 2 have the same volume.

### (First Core and Second Core)

As shown in FIG. 2, the magnetic core 3 includes the first core 3a and the second core 3b. In the present embodiment, the first core 3a has an E shape, and the second core 3b has a T shape. That is to say, the magnetic core 3 is an E-T type core including the E-shaped first core 3a and the T-shaped second core 3b.

### (First Core)

The first core 3a includes the first end core portion 35a and at least a portion of the side core portions 33. In the present embodiment, the first core 3a includes the first end core portion 35a, the first middle core portion 31a, the first side core portion 331, and the second side core portion 332. That is to say, the first core 3a includes the entire side core portions 33. The first middle core portion 31a, the first end core portion 35a, the first side core portion 331, and the second side core portion 332 are formed as a single piece. The first core 3a is a molded article formed as a single piece, and accordingly, the core portions included in the first core 3a are formed of the same material. That is to say, the core portions included in the first core 3a have substantially the same magnetic properties. The first core 3a has an E shape in a plan view.

### (Second Core)

The second core 3b includes the second end core portion 35b and the remaining portion of the side core portions 33. In the present embodiment, the second core 3b includes the second end core portion 35b and the second middle core portion 31b. The second end core portion 35b and the second middle core portion 31b are formed as a single piece. The second core 3b is a molded article formed as a single piece, and accordingly, the core portions included in the second core 3b are formed of the same material. That is to say, the core portions included in the second core 3b have substantially the same magnetic properties. The second core 3b has a T shape in a plan view.

At least one of the first core 3a and the second core 3b includes at least a portion of the middle core portion 31. The first core 3a may include the entire middle core portion 31. If the first core 3a includes the entire middle core portion 31, the second core 3b includes only the second end core portion 35b. In this case, the second core 3b has an I shape in a plan view. The second core 3b may include the entire middle core portion 31. If the second core 3b includes the entire middle core portion 31, the first core 3a is composed of the first end core portion 35a, the first side core portion 331, and the second side core portion 332. In this case, the first core 3a has a U shape in a plan view.

The side core portions 33 may be divided in the X-axis direction. In this case, the first side core portion 331 and the second side core portion 332 each include a first portion including the first end 34a and a second portion including the second end 34b. A configuration is also possible in which the first core 3a includes the first portions of the first side core portion 331 and the second side core portion 332, and the second core 3b includes the second portions of the first side core portion 331 and the second side core portion 332. In this case, the first core 3a and the second core 3b each have an E shape in a plan view.

### <Relative Permeability of First Core and Second Core>

The relative permeability of the first core 3a is lower than the relative permeability of the second core 3b. That is to say, the relative permeability of the side core portions 33 is lower than the relative permeability of the second end core portion 35b in the magnetic core 3. The relative permeabilities of the first core 3a and the second core 3b are set as appropriate such that the above relationship is satisfied and a predetermined inductance can be obtained. The relative permeability of the first core 3a is 5 or more and 50 or less, for example. The relative permeability of the second core 3b is 50 or more and 500 or less, for example. If the relative permeability of the first core 3a is within the range of 5 or more and 50 or less and the relative permeability of the second core 3b is within the range of 50 or more and 500 or less, the predetermined inductance can be easily obtained. The relative permeability of the first core 3a may be 10 or more and 45 or less, or 15 or more and 40 or less. The relative permeability of the second core 3b may be 100 or more and 450 or less, or 150 or more and 400 or less. The difference between the relative permeability of the first core 3a and the relative permeability of the second core 3b is 50 or more, for example. The difference between the relative permeability of the first core 3a and the relative permeability of the second core 3b may be 50 or more and 450 or less, or 100 or more and 400 or less.

The relative permeability can be obtained as follows. Ring-shaped measurement samples are cut out from the first core 3a and the second core 3b. Each measurement sample is provided with 300 turns of winding on the primary side and 20 turns of winding on the secondary side. A B-H initial magnetization curve is measured within a range where His 0 (Oe) or more and 100 (Oe) or less, and the maximum B/H value of the B-H initial magnetization curve is determined. The maximum value is taken to be the relative permeability. The magnetization curve referred to here is a so-called DC magnetization curve.

### <Materials of First Core and Second Core>

The first core 3a and the second core 3b are each constituted by a molded body of a soft magnetic material. The molded body is a powder compact or a molded body of a composite material, for example. The first core 3a and the second core 3b are constituted by molded bodies of materials different from each other. The wording “materials different from each other” of course means a case where individual constituent elements of the respective materials of the molded bodies constituting the first core 3a and the second core 3b differ from each other, as well as a case where the molded bodies are formed of the same constituent element but the contents of the constituent element in the molded bodies differ from each other. For example, when the first core 3a and the second core 3b are constituted by powder compacts, if at least either materials of soft magnetic powders forming the powder compacts or the contents of the materials differ from each other, the materials of the first core 3a and the second core 3b are different from each other. Also, when the first core 3a and the second core 3b are constituted by molded bodies of composite materials, if at least either materials of soft magnetic powders included in the composite materials or the contents of the materials differ from each other, the materials of the first core 3a and the second core 3b are different from each other.

A powder compact is obtained by compression molding of raw material powder including soft magnetic powder. The content of the soft magnetic powder in the powder compact is higher than the content of the soft magnetic powder in a molded body of a composite material. Therefore, magnetic properties of the powder compact are higher than magnetic properties of a molded body of a composite material. Examples of the magnetic properties include relative permeability and saturation magnetic flux density. The powder compact may also contain at least one of a binder resin and a molding aid, for example. The content of the soft magnetic powder in the powder compact is, for example, 85% by volume or more and 99.99% by volume or less when the volume of the powder compact is taken to be 100%.

A molded body of a composite material contains soft magnetic powder dispersed in resin. The molded body of a composite material is obtained by filling a mold with a fluid material obtained by dispersing the soft magnetic powder in unsolidified resin, and solidifying the resin. The content of the soft magnetic powder in the molded body of a composite material can be easily adjusted. Therefore, magnetic properties of the molded body of a composite material can be easily adjusted. The content of the soft magnetic powder in the molded body of a composite material is, for example, 20% by volume or more and 80% by volume or less when the volume of the molded body of a composite material is taken to be 100%.

Particles of the soft magnetic powder are at least one type of particles selected from the group consisting of particles of a soft magnetic metal, coated particles of a soft magnetic metal including insulating coating on outer surfaces, and particles of a soft magnetic non-metal material. The soft magnetic metal is, for example, pure iron or an iron-based alloy. The iron-based alloy is, for example, a Fe (iron)-Si (silicon) alloy or a Fe—Ni (nickel) alloy. The insulating coating is constituted by a phosphate, for example. The soft magnetic non-metal material is, for example, ferrite.

In the present embodiment, the first core 3a is constituted by a molded body of a composite material. The second core 3b is constituted by a powder compact. Since the first core 3a is constituted by a molded body of a composite material and the second core 3b is constituted by a powder compact, magnetic properties of the magnetic core 3 as a whole can be adjusted. Furthermore, if the first core 3a is constituted by a molded body of a composite material, it is easy to make the relative permeability of the first core 3a fall within the range of 5 or more and 50 or less. If the second core 3b is constituted by a powder compact, it is easy to make the relative permeability of the second core 3b fall within the range of 100 or more and 500 or less.

### Embodiment 2

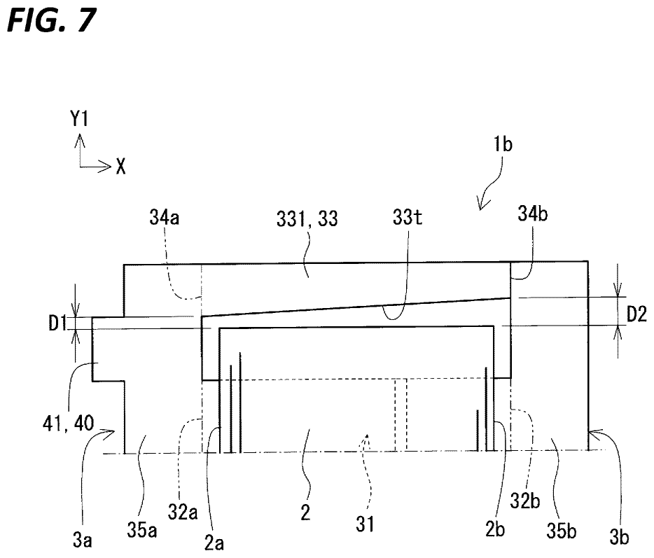

The following describes a reactor 1b according to Embodiment 2 with reference to FIGS. 6 and 7. The reactor 1b according to Embodiment 2 differs from the reactor 1a according to Embodiment 1 in that a second distance between each side core portion 33 and the coil 2 at the second end 34b is larger than a first distance between each side core portion 33 and the coil 2 at the first end 34a. The following mainly describes differences from Embodiment 1. Configurations that are the same as those in Embodiment 1 are denoted by the same reference numerals as those used in Embodiment 1, and descriptions thereof are omitted.

In the reactor 1b according to Embodiment 2, the first end core portion 35a includes the protrusions 40, and the reactor 1b satisfies the following requirements (c) and (d).

(c) The relative permeability of the first core 3a is lower than the relative permeability of the second core 3b.

(d) As shown in FIG. 7, a second distance D2 is larger than a first distance D1, and a ratio D1/D2 between the first distance D1 and the second distance D2 is 0.32 or more and 0.70 or less.

In the reactor 1b, the second distance D2 is larger than the first distance D1, and therefore, the loss of the coil 2 can be further reduced. In particular, the ratio D1/D2 between the first distance D1 and the second distance D2 is 0.32 or more and 0.70 or less, and therefore, it is possible to effectively reduce the loss of the coil 2 while suppressing a reduction in the inductance.

<Distance between Side Core Portion and Coil>

In the present embodiment, the distance between the first side core portion 331 and the coil 2 and the distance between the second side core portion 332 and the coil 2 are not constant across the X-axis direction. That is to say, the distance between each side core portion 33 and the coil 2 is not constant across the entire length of the side core portion 33. The distance between each side core portion 33 and the coil 2 increases in the direction from the first end 34a toward the second end 34b. The distance between each side core portion 33 and the coil 2 is the distance between the inner surface of the side core portion 33 and the outer circumferential surface of the coil 2.

The following specifically describes the distance between each side core portion 33 and the coil 2 with reference to FIG. 7. FIG. 7 shows only a half of the reactor 1b shown in FIG. 6 including the first side core portion 331, out of two sections of the reactor 1b divided along the center line of the middle core portion 31. Here, the distance between the first side core portion 331 and the coil 2 will be described with reference to FIG. 7, but the same also applies to the distance between the second side core portion 332 and the coil 2. The second distance D2 between the first side core portion 331 and the coil 2 at the second end 34b is larger than the first distance D1 between the first side core portion 331 and the coil 2 at the first end 34a. The first distance D1 is the distance between the inner surface of the first side core portion 331 at the first end 34a and a virtual plane extending from the outer circumferential surface of the coil 2. If a corner between the end surface at the first end 34a and the inner surface is chamfered, it is assumed that the chamfering has not been performed. That is to say, a distance between the virtual plane described above and a corner formed by a plane extending from the end surface at the first end 34a and a plane extending from the inner surface is taken to be the first distance D1. The second distance D2 is the distance between the inner surface of the first side core portion 331 at the second end 34b and the virtual plane extending from the outer circumferential surface of the coil 2. If a corner between the end surface at the second end 34b and the inner surface is chamfered, it is assumed that the chamfering has not been performed. That is to say, a distance between the virtual plane described above and a corner formed by a plane extending from the end surface at the second end 34b and a plane extending from the inner surface is taken to be the second distance D2.

The ratio between the first distance D1 and the second distance D2 is 0.32 or more and 0.70 or less. The ratio between the first distance D1 and the second distance D2 is expressed as D1/D2. The smaller the ratio D1/D2 is, the larger the second distance D2 is. The larger the second distance D2 is, the larger the distance between the side core portion 33 and the coil 2 becomes in the vicinity of the second end 34b. Therefore, it is possible to suppress linkage between the coil 2 and a leaking magnetic flux making a shortcut from the side core portion 33 toward the second end core portion 35b in the vicinity of the second end 34b. As a result of the reduction of the magnetic flux leakage to the coil 2, the loss of the coil 2 can be reduced. If the ratio D1/D2 is 0.70 or less, the magnetic flux leakage to the coil 2 is sufficiently suppressed, and accordingly, the loss of the coil 2 can be effectively reduced. If the ratio D1/D2 is too small, i.e., if the second distance D2 is too large, there is a risk of a reduction in the inductance and it may be difficult to obtain the predetermined inductance. If the ratio D1/D2 is 0.32 or more, the reduction in the inductance is likely to be suppressed. The ratio D1/D2 may be 0.35 or more and 0.70 or less, or 0.40 or more and 0.60 or less.

In FIG. 6, the above-described distance D33 between the middle core portion 31 and the first side core portion 331 (see FIG. 3) is the distance between the outer circumferential surface of the middle core portion 31 at the first end 32a and the inner surface of the side core portion 33 at the first end 34a.

### <Shape of Side Core Portions

The side core portions 33 are formed such that the width of the side core portions 33 decreases in the direction from the first end 34a toward the second end 34b. It is sufficient that the side core portions 33 are formed such that the width at the second end 34b is smaller than the width at the first end 34a. The side core portions 33 may include a portion in which the width is constant between the first end 34a and the second end 34b as long as the width of each side core portion 33 decreases at least in a portion between the first end 34a and the second end 34b. The width of each side core portion 33 is the length of the side core portion 33 in the Y-axis directions. In the present embodiment, the shape of the first side core portion 331 and the shape of the second side core portion 332 are symmetrical with each other with respect to the center line of the middle core portion 31.

The following specifically describes the shape of the side core portions 33 according to the present embodiment with reference to FIG. 7. Here, the shape of the first side core portion 331 will be described. d. The first side core portion 331 has a tapered shape. The tapered shape is a shape including a portion in which the width continuously decreases in the direction from the first end 34a toward the second end 34b. In the present embodiment, the first side core portion 331 has a tapered shape across its entire length. The inner surface of the first side core portion 331 includes an inclined surface 33t inclined with respect to the outer circumferential surface of the coil 2. The inclined surface 33t is inclined such that the distance between the inclined surface 33t and the outer circumferential surface of the coil 2 increases in the direction from the first end 34a toward the second end 34b. The angle of the inclined surface 33t with respect to the outer circumferential surface of the coil 2 is set as appropriate such that the ratio between the first distance D1 and the second distance D2 falls within the predetermined range. The angle of the inclined surface 33t is the angle between the inclined surface 33t and the outer circumferential surface of the coil 2. The outer circumferential surface of the coil 2 is parallel to the X axis. The angle of the inclined surface 33t can be set as appropriate according to the length of the first side core portion 331. The angle of the inclined surface 33t is, for example, 1° or more and less than 5°, or 2° or more and 4° or less.

In FIG. 8, the above-described distance D33 between the middle core portion 31 and the first side core portion 331 (see FIG. 3) is the distance between the outer circumferential surface of the middle core portion 31 at the first end 32a and the inner surface of the side core portion 33 at the first end 34a.

### Variation

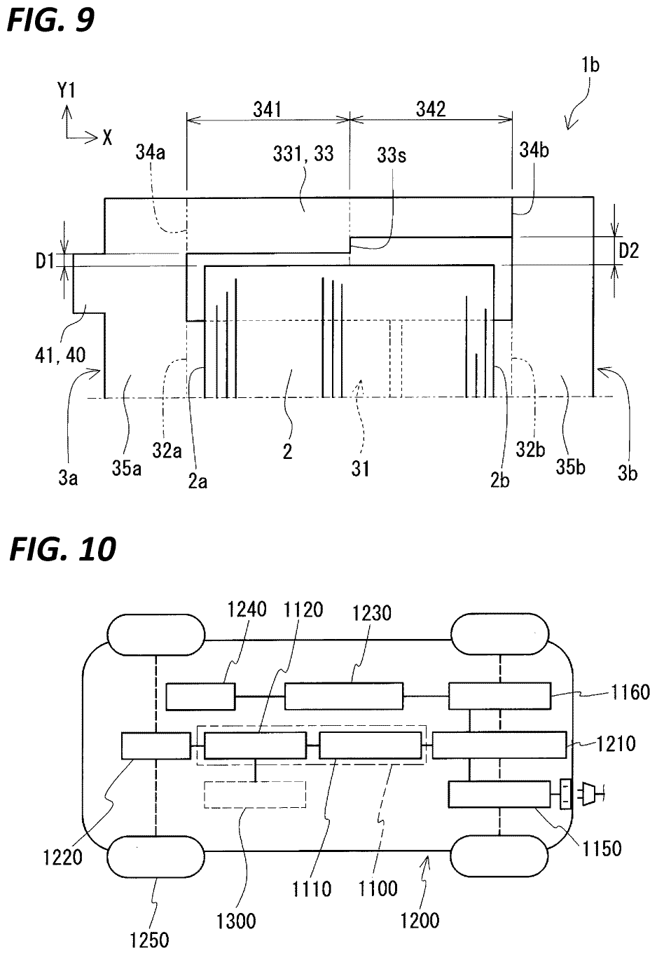

The following describes a variation of the reactor 1b according to Embodiment 2 with reference to FIGS. 8 and 9. In the reactor 1b according to the variation shown in FIGS. 8 and 9, the side core portions 33 have a stepped shape.

The following specifically describes the shape of the side core portions 33 according to the variation with reference to FIG. 9. Here, the shape of the first side core portion 331 will be described. The side core portions 33 have a stepped shape. The stepped shape is a shape including a portion in which the width decreases stepwise in the direction from the first end 34a toward the second end 34b. The inner surface of the first side core portion 331 has a step 33s. In the variation, the step 33s is located at the middle of the length of the first side core portion 331. The first side core portion 331 is divided into two regions by the single step 33s. A region from the first end 34a to the step 33s is a first region 341. A region from the step 33s to the second end 34b is a second region 342. The width of the second region 342 is smaller than the width of the first region 341. The inner surface of the first region 341 and the inner surface of the second region 342 are parallel to the outer circumferential surface of the coil 2. The distance between the inner surface of the second region 342 and the outer circumferential surface of the coil 2 is larger than the distance between the inner surface of the first region 341 and the outer circumferential surface of the coil 2. The width of the step 33s is set as appropriate such that the ratio between the first distance D1 and the second distance D2 falls within the predetermined range. The width of the step 33s corresponds to the length of the step 33s in the Y-axis directions. The width of the step 33s is equal to a difference between the distance from the outer circumferential surface of the coil 2 to the inner surface of the second region 342 and the distance from the outer circumferential surface of the coil 2 to the inner surface of the first region 341. That is to say, the width of the step 33s is expressed as D2-D1. The width of the step 33s is, for example, 1 mm or more and less than 5 mm, or 1.25 mm or more and 4 mm or less.

A single step 33s is provided in the variation, but a plurality of steps 33s may also be provided. If the number of steps 33s is n, the number of regions included in the side core portion 33 is n+1. The (n+1)-th region is closer to the second end 34b than the n-th region is, and the width of the (n+1)-th region is smaller than the width of the n-th region. The width decreases stepwise in the direction from the first region toward the (n+1)-th region.

The side core portions 33 may also have a shape obtained by combining a tapered shape and a stepped shape. Examples of variations of the shape of the side core portions 33 include the followings.

(1) The side core portion shown in FIG. 9 may be configured such that the first region 341 has a tapered shape, the step 33s is not provided between the first region 341 and the second region 342, and the second region 342 has a constant width.

(2) The side core portion shown in FIG. 9 may be configured such that the first region 341 has a tapered shape, the step 33s is provided between the first region 341 and the second region 342, and the second region 342 has a constant width.

(3) The side core portion shown in FIG. 9 may be configured such that the first region 341 has a constant width, the step 33s is not provided between the first region 341 and the second region 342, and the second region 342 has a tapered shape.

(4) The side core portion shown in FIG. 9 may be configured such that the first region 341 has a constant width, the step 33s is provided between the first region 341 and the second region 342, and the second region 342 has a tapered shape.

### Embodiment 3

### [Converter and Power Conversion Device]

A reactor according to the embodiment can be used in applications that satisfy the following energization conditions. The energization conditions are, for example, the maximum DC current is about 100 A or more and 1000 A or less, an average voltage is about 100 V or more and 1000 V or less, and an operating frequency is about 5 kHz or more and 100 kHz or less. The reactor according to the embodiment can be typically used as a component of a converter installed in, for example, a vehicle such as an electric vehicle or a hybrid vehicle, and a component of a power conversion device including the converter.

As shown in FIG. 10, a vehicle 1200 such as a hybrid vehicle or an electric vehicle includes a main battery 1210, a power conversion device 1100 connected to the main battery 1210, and a motor 1220 that is driven with power supplied from the main battery 1210 and is used to travel. The motor 1220 is typically a three-phase AC motor. The motor 1220 drives wheels 1250 during travel and functions as a generator during regeneration. In the case of a hybrid vehicle, the vehicle 1200 includes an engine 1300 in addition to the motor 1220. FIG. 10 shows an inlet as a charging unit of the vehicle 1200, but a configuration is also possible in which the vehicle 1200 includes a plug.

The power conversion device 1100 includes a converter 1110 connected to the main battery 1210 and an inverter 1120 that is connected to the converter 1110 and performs conversion between DC and AC. The converter 1110 shown in this example steps up an input voltage of the main battery 1210, which is about 200 V or more and 300 V or less, to about 400 V or more and 700 V or less and supplies power to the inverter 1120 while the vehicle 1200 is traveling. The converter 1110 steps down an input voltage that is output from the motor 1220 via the inverter 1120 to a DC voltage suitable for the main battery 1210 and charges the main battery 1210 during regeneration. The input voltage is a DC voltage. The inverter 1120 converts the DC stepped up by the converter 1110 to a predetermined AC and supplies power to the motor 1220 while the vehicle 1200 is traveling, and converts an AC output from the motor 1220 to a DC and outputs the DC to the converter 1110 during regeneration.

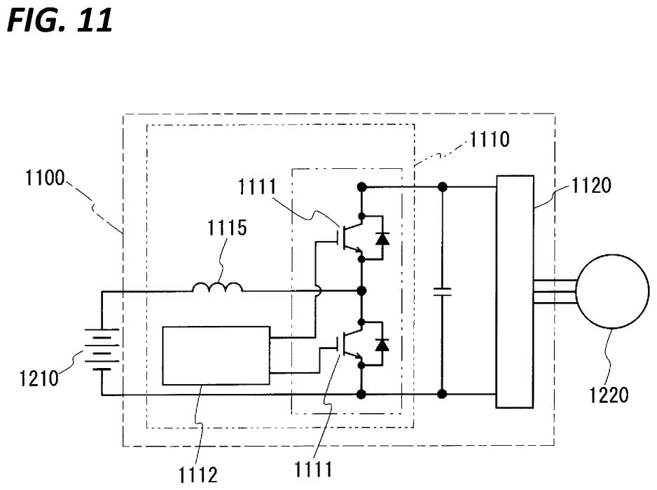

As shown in FIG. 11, the converter 1110 includes a plurality of switching elements 1111, a drive circuit 1112 that controls operations of the switching elements 1111, and a reactor 1115, and converts an input voltage by repeatedly turning the switching elements on or off. The conversion of an input voltage referred to here means stepping up or down the voltage. Power devices such as field-effect transistors and insulated gate bipolar transistors are used as the switching elements 1111. The reactor 1115 has a function of smoothing an increase or decrease of a current caused by a switching operation by using characteristics of a coil that prevents a change in a current flowing into a circuit. The reactor according to the embodiment is included as the reactor 1115. The power conversion device 1100 and the converter 1110 have a small loss due to including the reactor according to the embodiment.

The vehicle 1200 includes, in addition to the converter 1110, a power supply device converter 1150 connected to the main battery 1210, and an auxiliary device power supply converter 1160 that is connected to the main battery 1210 and a sub battery 1230 used as a power source for auxiliary devices 1240 and converts a high voltage from the main battery 1210 to a low voltage. The converter 1110 typically performs DC-DC conversion, but the power supply device converter 1150 and the auxiliary device power supply converter 1160 perform AC-DC conversion. Examples of the power supply device converter 1150 include a converter that performs DC-DC conversion. It is possible to use a reactor that is configured similarly to the reactor according to the embodiment and whose size, shape, or the like is changed from that of the reactor according to the embodiment as appropriate, as a reactor in the power supply device converter 1150 or a reactor in the auxiliary device power supply converter 1160. The reactor according to the embodiment can also be used in a converter that converts input power and performs only a step-up operation or a step-down operation.

### Test Example 1

Reactors configured similarly to the reactor 1a according to Embodiment 1 were evaluated in terms of the inductance and the loss.

In test example 1, reactors of sample Nos. 1-0 to 1-7 shown in Table 1 were designed. The sample Nos. 1-0 to 1-7 are models obtained by changing the length L40 of each of the first protrusion 41 and the second protrusion 42 within a range from 0 mm to 10 mm. The sample No. 1-0 in which the length L40 of the protrusions 40 was 0 mm did not have the first protrusion 41 and the second protrusion 42. Basic configurations of the designed reactors are shown below.

### (Size of Magnetic Core)·

Length L of magnetic core 3: 80 mm
Width W of magnetic core 3: 65 mm
Height H of magnetic core 3: 25 mm

As shown in FIG. 1, the length L is the length of the magnetic core 3 in the X-axis direction. The width W is the length of the magnetic core 3 in the Y-axis directions. The height H is the length of the magnetic core 3 in the Z-axis direction.

### (Sizes of Core Portions)

Length of middle core portion 31: 53.2 mm
Width of middle core portion 31: 25 mm
Length of each of first side core portion 331 and second side core portion 332: 53.2 mm
Width of each of first side core portion 331 and second side core portion 332: 9 mm
Length of each of first end core portion 35a and second end core portion 35b: 13.4 mm
Width of each of first end core portion 35a and second end core portion 35b: 65 mm
Length of gap portion 31g: 2 mm
Distance between middle core portion 31 and first side core portion 331: 11 mm
Distance between middle core portion 31 and second side core portion 332: 11 mm The length of each core portion is the length in the X-axis direction. The width of each core portion is the length in the Y-axis directions. The height of each core portion, i.e., the length in the Z-axis direction was 25 mm.
Relative permeability of first core 3a: 20
Relative permeability of second core 3b: 200

Table 1 shows the length L40 of the protrusions 40, the length L35 of the first end core portion 35a, and the ratio (L40/L35) between the length L40 and the length L35 in the sample Nos. 1-0 to 1-7. Note that the first protrusion 41 and the second protrusion 42 each had a width W40 of 11 mm. The distance D33 between the middle core portion 31 and each side core portion 33 was 11 mm. The ratio (W40/D33) between the width W40 and the distance D33 was 1.

The inductance and the loss of the reactor of each sample were analyzed. In the analysis of the inductance and the loss, JMAG-Designer 21.0, which is commercially available electromagnetic field analysis software manufactured by JSOL CORPORATION, was used and magnetic field transient response analysis was performed.

### (Analysis of Inductance)

The inductance was analyzed by causing an electric current to flow through the coil with a current value of 0 A to 400 A. The maximum value of the inductance was determined from magnetic flux linkage of the coil when the current value was 0 A. The inductances of the samples are shown in Table 1. The inductances shown in Table 1 are expressed as ratios to the inductance (100%) of the sample No. 1-0.

### (Analysis of Loss)

A loss at the time when a voltage was applied to the coil with a DC current of 0 A, an input voltage of 300 V, an output voltage of 600 V, and a frequency of 20 kHz was analyzed. The loss of the coil was determined from a magnetic flux density distribution and a current density distribution. The loss of the coil of each sample is shown in Table 1. The loss of the coil is expressed as a ratio to the loss (100%) of the coil of the sample No. 1-0. Also, a coil loss reduction rate A of each sample is shown in Table 1. The coil loss reduction rate A was obtained by subtracting the loss of the coil of the sample No. 1-0 from the loss of the coil of each sample. If the coil loss reduction rate A is 1% or more, it is considered that the effect of reducing the loss of the coil was achieved.

### (Evaluation of Volume Increase Rate)

The volume of the magnetic core of the reactor of each sample was measured. Here, the volume of the first core of each sample was determined. Volume increase rates of the first cores of the sample Nos. 1-1 to 1-7 relative to the volume of the first core of the sample No. 1-0 were calculated. The volume increase rates were determined as follows. A volume increase amount of the first core of each sample relative to the volume of the first core of the sample No. 1-0 was calculated. The volume increase amount was obtained by subtracting the volume of the first core of the sample No. 1-0 from the volume of the first core of each sample. The volume increase rate is a percentage of the volume increase amount Va of the first core of each sample relative to the volume V0 of the first core of the sample No. 1-0. That is to say, the volume increase rate is expressed as [Va/V0]×100. The volume increase rate B of each sample is shown in Table 1.

### (Evaluation of Efficiency)

The efficiency of a reduction in the coil loss relative to an increase in the volume of the first core was evaluated with respect to the reactor of each sample. The efficiency is expressed as a percentage of the coil loss reduction rate A relative to the volume increase rate B. The efficiency is expressed as [A/B]×100. The efficiency of each sample is shown in Table 1. If the efficiency is 75% or higher, it can be said that the efficiency of the reduction in the loss of the coil is high.

TABLE 1

| | No. 1-0 | No. 1-1 | No. 1-2 | No. 1-3 | No. 1-4 | No. 1-5 | No. 1-6 | No. 1-7 |
|---|---|---|---|---|---|---|---|---|
| L40 (mm) | 0 | 1 | 2.5 | 4 | 5.5 | 7 | 8.5 | 10 |
| L35 (mm) | 13.4 | 13.4 | 13.4 | 13.4 | 13.4 | 13.4 | 13.4 | 13.4 |
| L40/L35 | 0 | 0.07 | 0.19 | 0.30 | 0.41 | 0.52 | 0.63 | 0.75 |
| Inductance (%) | 100 | 100.2 | 100.5 | 100.7 | 100.9 | 101.0 | 101.2 | 101.4 |
| Coil loss (%) | 100 | 98.8 | 97.8 | 97.1 | 96.5 | 95.9 | 95.4 | 94.8 |
| Coil loss reduction rate A | 0 | 1.2 | 2.2 | 2.9 | 3.5 | 4.1 | 4.6 | 5.2 |
| (%) | | | | | | | | |
| Volume increase rate B | 0 | 0.8 | 2.1 | 3.4 | 4.6 | 5.9 | 7.1 | 8.4 |
| (%) | | | | | | | | |
| Efficiency [A/B] (%) | 0 | 150 | 105 | 85 | 76 | 69 | 65 | 62 |

As shown in Table 1, the coil loss reduction rate A was 1% or more in the sample Nos. 1-1 to 1-7. That is to say, in the sample Nos. 1-1 to 1-7, the loss of the coil was reduced by 1% or more compared with the loss of the coil of the sample No. 1-0. This indicates that the effect of reducing the loss of the coil was achieved due to the protrusions in the sample Nos. 1-1 to 1-7. Also, in the sample Nos. 1-1 to 1-7, the inductance did not decrease compared with the inductance of the sample No. 1-0. It can be said that the influence of the protrusions on the inductance was small.

In the sample Nos. 1-1 to 1-7, the ratio between the length L40 of the protrusions and the length L35 of the first end core portion, i.e., L40/L35 was 0.05 or more. From the results of the sample Nos. 1-1 to 1-7, it can be found that the larger the length L40 is, i.e., the larger the ratio between the length L40 and the length L35 is, the higher the effect of reducing the loss of the coil tends to become. However, if the ratio between the length L40 and the length L35 is too large, the first core has a large volume, leading to an increase in the volume increase rate B. An increase in the volume increase rate B tends to result in a decrease in the efficiency. In the sample Nos. 1-1 to 1-4 in which L40/L35 was no greater than 0.5, the efficiency was high and 75% or higher. It is considered that, when the ratio between the length L40 and the length L35 is 0.05 or more and 0.5 or less, the effect of reducing the loss of the coil can be achieved with a high efficiency.

### Test Example 2

In test example 2, reactors of sample Nos. 2-0 to 2-7 shown in Table 2 were designed. The sample Nos. 2-0 to 2-7 are models obtained by changing the width W40 of each of the first protrusion 41 and the second protrusion 42 within a range from 0 mm to 10 mm. The sample No. 2-0 in which the width W40 of the protrusions 40 was 0 mm did not have the first protrusion 41 and the second protrusion 42. The sample No. 2-0 had the same configuration as the sample No. 1-0 of the test example 1. Basic configurations of the designed reactors were the same as those in the test example 1.

Table 2 shows the width W40 of the protrusions 40, the distance D33 between the middle core portion 31 and each side core portion 33, and the ratio (W40/D33) between the width W40 and the distance D33 in the sample Nos. 2-0 to 2-7. Note that the first protrusion 41 and the second protrusion 42 each had a length L40 of 5 mm. The first end core portion 35a had a length L35 of 13.4 mm. The ratio (L40/L35) between the length L40 and the length L35 was 0.37.

The inductance and the loss of the reactor of each sample were analyzed. The inductance and the loss of the coil of each sample were determined in the same manner as in the test example 1. The inductance and the loss of the coil of each sample are shown in Table 2. The inductances shown in Table 2 are expressed as ratios to the inductance (100%) of the sample No. 2-0. The coil losses shown in Table 2 are expressed as ratios to the loss (100%) of the coil of the sample No. 2-0. Also, the coil loss reduction rate A of each sample is shown in Table 1. The coil loss reduction rate A was obtained by subtracting the loss of the coil of the sample No. 2-0 from the loss of the coil of each sample.

Furthermore, the volume increase rate and the efficiency of each sample were determined in the same manner as in the test example 1. The volume increase rate B and the efficiency of each sample are shown in Table 2.

TABLE 2

| | No. 2-0 | No. 2-1 | No. 2-2 | No. 2-3 | No. 2-4 | No. 2-5 | No. 2-6 | No. 2-7 |
|---|---|---|---|---|---|---|---|---|
| W40 (mm) | 0 | 1 | 2.5 | 4 | 5.5 | 7 | 8.5 | 10 |
| D33 (mm) | 11 | 11 | 11 | 11 | 11 | 11 | 11 | 11 |
| W40/D33 | 0 | 0.09 | 0.23 | 0.36 | 0.50 | 0.64 | 0.77 | 0.91 |
| Inductance (%) | 100 | 100.3 | 100.4 | 100.5 | 100.5 | 100.6 | 100.7 | 100.7 |
| Coil loss (%) | 100 | 99.1 | 98.8 | 98.6 | 98.2 | 97.8 | 97.4 | 97.0 |
| Coil loss reduction rate A | 0 | 0.9 | 1.2 | 1.4 | 1.8 | 2.2 | 2.6 | 3.0 |
| (%) | | | | | | | | |
| Volume increase rate B | 0 | 0.4 | 1.0 | 1.5 | 2.1 | 2.7 | 3.2 | 3.8 |
| (%) | | | | | | | | |
| Efficiency [A/B] (%) | 0 | 225 | 120 | 93 | 86 | 81 | 81 | 79 |

As shown in Table 2, the coil loss reduction rate A was 1% or more in the sample Nos. 2-2 to 2-7. This indicates that the effect of reducing the loss of the coil was achieved due to the protrusions in the sample Nos. 2-2 to 2-7. Also, in the sample Nos. 2-2 to 2-7, the inductance did not decrease compared with the inductance of the sample No. 2-0. It can be said that the influence of the protrusions on the inductance was small.

In the sample Nos. 2-2 to 2-7, the ratio between the width W40 of the protrusions and the distance D33 between the middle core portion and each side core portion, i.e., W40/D33 was 0.2 or more. From the results of the sample Nos. 2-1 to 2-7, it can be found that the larger the width W40 is, i.e., the larger the ratio between the width L40 and the distance D33 is, the higher the effect of reducing the loss of the coil tends to become. Moreover, in the sample Nos. 2-2 to 2-7 in which W40/D33 was no greater than 1.0, the efficiency was high and 75% or higher. It is considered that, when the ratio between the width 40 and the distance 33 is 0.2 or more and 1.0 or less, the effect of reducing the loss of the coil can be achieved with a high efficiency.

### Test Example 3

Reactors according to the variation 1 and the variation 2 were evaluated in terms of the inductance and the loss.

In test example 3, reactors of sample Nos. 3-1 and 3-2 shown in Table 3 were designed. The sample Nos. 3-1 and 3-2 each had the first protrusion 41 and the second protrusion 42. Basic configurations of the designed reactors were the same as those in the test example 1.

The sample No. 3-1 had the same configuration as the variation 1. In the sample No. 3-1, the first protrusion 41 and the second protrusion 42 were each divided into two protrusions in the Z-axis direction. In the sample No. 3-1, the protrusions were disposed in a part near the upper edge and a part near the lower edge of the outer surface 352a. The two protrusions arranged in the Z-axis direction had the same size. The two protrusions each had a height of 7.5 mm in the Z-axis direction. The sum of the heights of the two protrusions was 15 mm.

The sample No. 3-2 had the same configuration as the variation 2. In the sample No. 3-2, the first protrusion 41 and the second protrusion 42 were each disposed only in a center portion of the outer surface 352a. The protrusions each had a height of 15 mm in the Z-axis direction.

In the sample Nos. 3-1 and 3-2, the first protrusion 41 and the second protrusion 42 each had a length L40 of 5.5 mm. The ratio (L40/L35) between the length L40 and the length L35 was 0.41. The first protrusion 41 and the second protrusion 42 each had a width W40 of 11 mm. The ratio (W40/D33) between the width W40 and the distance D33 was 1. The protrusions in the sample No. 3-1 and the protrusions in the sample No. 3-2 had the same volume. That is to say, the first core in the sample No. 3-1 and the first core in the sample No. 3-2 had the same volume.

The inductance and the loss of the reactor of each sample were analyzed. The inductance and the loss of the coil of each sample were determined in the same manner as in the test example 1. The inductance and the loss of the coil of each sample are shown in Table 3. The inductances shown in Table 3 are expressed as ratios to the inductance (100%) of the sample No. 1-0 in the test example 1. The coil losses shown in Table 3 are expressed as ratios to the loss (100%) of the coil of the sample No. 1-0. Also, the coil loss reduction rate A of each sample is shown in Table 1. The coil loss reduction rate A was obtained by subtracting the loss of the coil of the sample No. 1-0 from the loss of the coil of each sample.

TABLE 3

| | No. 3-1 | No. 3-2 |
|---|---|---|
| Inductance (%) | 100.6 | 100.7 |
| Coil loss (%) | 97.3 | 97.7 |
| Coil loss reduction rate A (%) | 2.7 | 2.3 |

As shown in Table 3, the coil loss reduction rate A was 1% or more in the sample Nos. 3-1 and 3-2. From a comparison between the sample Nos. 3-1 and 3-2, it can be found that the loss of the coil of the sample No. 3-1 was smaller than the loss of the coil of the sample No. 3-2. From this result, it is considered that the loss of the coil can be reduced more effectively when the protrusions are disposed in a part near the upper edge and a part near the lower edge of the outer surface of the first end core portion.

### Test Example 4

Reactors configured similarly to the reactor 1b according to Embodiment 2 were evaluated in terms of the inductance and the loss.

In test example 4, reactors of sample Nos. 4-0 to 4-7 shown in Table 4 were designed. The sample Nos. 4-0 to 4-7 each had the first protrusion 41 and the second protrusion 42. The sample Nos. 4-0 to 4-7 are models obtained by changing the angle of the inclined surface 33t of the inner surface of each side core portion 33 within a range from 0° to 7°. The sample No. 4-0 had the same configuration as the sample No. 1-4 of the test example 1. Basic configurations of the designed reactors were the same as those in the test example 1.

In the sample Nos. 4-0 to 4-7, the first protrusion 41 and the second protrusion 42 each had a length L40 of 5.5 mm. The ratio (L40/L35) between the length L40 and the length L35 was 0.41. The first protrusion 41 and the second protrusion 42 each had a width W40 of 11 mm. The ratio (W40/D33) between the width W40 and the distance D33 was 1.

Table 4 shows the angles of the inclined surface in the sample Nos. 4-0 to 4-7. Table 4 also shows the first distance D1, the second distance D2, and the ratio (D1/D2) between the first distance D1 and the second distance D2 in each sample. In the sample No. 4-0 in which the angle of the inclined surface 33t was 0°, the distance between each side core portion 33 and the coil 2 was constant across the entire length of the side core portion 33. That is to say, the ratio between the first distance D1 and the second distance D2 was 1 in the sample No. 4-0. The first distance D1 and the second distance D2 were each 2 mm in the sample No. 4-0.

The inductance and the loss of the reactor of each sample were analyzed. The inductance and the loss of the coil of each sample were determined in the same manner as in the test example 1. The inductance and the loss of the coil of each sample are shown in Table 4. The inductances shown in Table 4 are expressed as ratios to the inductance (100%) of the sample No. 1-0 in the test example 1. The coil losses shown in Table 4 are expressed as ratios to the loss (100%) of the coil of the sample No. 1-0. Also, the coil loss reduction rate A of each sample is shown in Table 4. The coil loss reduction rate A was obtained by subtracting the loss of the coil of the sample No. 1-0 from the loss of the coil of each sample.

TABLE 4

| | No. 1-0 | No. 4-0 | No. 4-1 | No. 4-2 | No. 4-3 | No. 4-4 | No. 4-5 | No. 4-6 | No. 4-7 |
|---|---|---|---|---|---|---|---|---|---|
| Presence or absence | Absent | Present | Present | Present | Present | Present | Present | Present | Present |
| of protrusions | | | | | | | | | |
| Angle of inclined surface | 0 | 0 | 1 | 2 | 3 | 4 | 5 | 6 | 7 |
| (°) | | | | | | | | | |
| D1 (mm) | 2 | 2 | 2 | 2 | 2 | 2 | 2 | 2 | 2 |
| D2 (mm) | 2 | 2 | 2.9 | 3.8 | 4.7 | 5.7 | 6.6 | 7.5 | 8.5 |
| D1/D2 | 1 | 1 | 0.69 | 0.53 | 0.43 | 0.35 | 0.31 | 0.27 | 0.24 |
| Inductance (%) | 100 | 100.9 | 100.1 | 97.4 | 96.4 | 95.3 | 94.3 | 93.0 | 91.5 |
| Coil loss (%) | 100 | 96.5 | 95.2 | 94.1 | 93.2 | 92.6 | 92.4 | 92.4 | 93.1 |
| Coil loss reduction rate A | 0 | 3.5 | 4.8 | 5.9 | 7.8 | 7.4 | 7.6 | 7.6 | 6.9 |
| (%) | | | | | | | | | |

As shown in Table 4, in the sample Nos. 4-1 to 4-7, the loss of the coil was further reduced compared with the loss of the coil of the sample No. 4-0. In the sample Nos. 4-1 to 4-7, the second distance D2 was larger than the first distance D1, and the ratio between the first distance D1 and the second distance D2 was 0.70 or less. From the results of the sample Nos. 4-1 to 4-7, it can be found that the larger the second distance D2 is, i.e., the smaller the ratio between the first distance D1 and the second distance D2 is, the higher the effect of reducing the loss of the coil tends to become. However, it can be found that the inductance decreases as the ratio between the first distance D1 and the second distance D2 becomes smaller. In the sample Nos. 4-1 to 4-4, the inductance decreased less than 5% compared with the inductance of the sample No. 1-0. If the decrease in the inductance of a sample is less than 5%, the inductance of that sample can be considered to be substantially equivalent to the inductance of the sample No. 1-0. In the sample Nos. 4-1 to 4-4, the ratio between the first distance D1 and the second distance D2 was 0.32 or more. It is considered that, when the ratio between the first distance D1 and the second distance D2 is 0.32 or more and 0.70 or less, the effect of reducing the loss of the coil can be achieved while a favorable inductance is maintained.

### LIST OF REFERENCE NUMERALS

1a, 1b Reactor
2 Coil
2a First end surface
2b Second end surface
3 Magnetic core
3a First core
3b Second core
31 Middle core portion
31a First middle core portion
31b Second middle core portion
31g Gap portion
32a First end
32b Second end
33 Side core portion
331 First side core portion
332 Second side core portion
33t Inclined surface
33s Step
34a First end
34b Second end
341 First region
342 Second region
35 End core portion
35a First end core portion
35b Second end core portion
351a, 351b Inner surface
352a, 352b Outer surface
40 Protrusion
41 First protrusion
42 Second protrusion
D1 First distance
D2 Second distance
D33 Distance
L, L40, L35 Length
W, W40 Width
H Height
1100 Power conversion device
1110 Converter
1111 Switching element
1112 Drive circuit
1115 Reactor
1120 Inverter
1150 Power supply device converter
1160 Auxiliary device power supply converter
1200 Vehicle
1210 Main battery
1220 Motor
1230 Sub battery
1240 Auxiliary devices
1250 Wheel
1300 Engine

1. A reactor comprising:
a coil having a tubular shape; and
a magnetic core having a θ shape,
wherein the coil has a first end surface and a second end surface,
the magnetic core includes a first core and a second core,
the first core includes a first end core portion and at least a portion of side core portions, the second core includes a second end core portion and the remaining portion of the side core portions,
at least one of the first core and the second core includes at least a portion of a middle core portion,
the first end core portion is disposed in such a manner as to face the first end surface of the coil,
the second end core portion is disposed in such a manner as to face the second end surface of the coil,
the middle core portion is disposed inside the coil,
the side core portions include a first side core portion and a second side core portion disposed in parallel with the middle core portion in such a manner as to sandwich the coil,
the first core is constituted by a molded body of a composite material in which soft magnetic powder is dispersed in resin,
the first end core portion has:
an inner surface to which a first end of the middle core portion, a first end of the first side core portion, and a first end of the second side core portion are joined;
an outer surface facing a side opposite to the inner surface; and
protrusions provided on the outer surface,
the protrusions include a first protrusion and a second protrusion,
the first protrusion is provided in a region of the outer surface between the middle core portion and the first side core portion, and
the second protrusion is provided in a region of the outer surface between the middle core portion and the second side core portion.

2. The reactor according to claim 1,
wherein the first protrusion and the second protrusion each have a length that is at least 0.05 times a length of the first end core portion and no greater than 0.5 times the length of the first end core portion.

3. The reactor according to claim 1,
wherein the first protrusion has a width that is at least 0.2 times a distance between the middle core portion and the first side core portion and no greater than 1.0 times the distance between the middle core portion and the first side core portion, and
the second protrusion has a width that is at least 0.2 times a distance between the middle core portion and the second side core portion and no greater than 1.0 times the distance between the middle core portion and the second side core portion.

4. The reactor according to claim 1,
wherein the first core has a relative permeability of 5 or more and 50 or less.

5. The reactor according to claim 1,
wherein the middle core portion includes a first middle core portion and a second middle core portion,
the first middle core portion is joined to the first end core portion, and
the second middle core portion is joined to the second end core portion.

6. The reactor according to claim 5,
wherein the middle core portion includes a gap portion between the first middle core portion and the second middle core portion.

7. The reactor according to claim 1,
wherein the first core includes the entire side core portions,
the first core has a relative permeability that is lower than a relative permeability of the second core,
the first side core portion and the second side core portion each have the first end that is joined to the first end core portion and a second end that is joined to the second end core portion,
a second distance between the coil and each of the first side core portion and the second side core portion at the second end is larger than a first distance between the coil and each of the first side core portion and the second side core portion at the first end, and
a ratio between the first distance and the second distance is 0.32 or more and 0.70 or less.

8. The reactor according to claim 7,
wherein the first side core portion and the second side core portion each have a tapered shape whose width decreases in a direction from the first end toward the second end.

9. The reactor according to claim 7,
wherein the first side core portion and the second side core portion each have a stepped shape whose width decreases in a direction from the first end toward the second end.

10. The reactor according to claim 1,
wherein the second core has a relative permeability of 100 or more and 500 or less.

11. The reactor according to claim 1,
wherein the second core is constituted by a powder compact.

12. A converter comprising the reactor according to claim 1.

13. A power conversion device comprising the converter according to claim 12.
